(19) United States
(12) Patent Application Publication
(10) Pub. No.: US 2009/0112704 A1
(43) Pub. Date: Apr. 30, 2009

(54) MANAGEMENT TOOL FOR EFFICIENT ALLOCATION OF SKILLS AND RESOURCES

(75) Inventor: Salvatore Branca, Rome (IT)

Correspondence Address: IBM CORP. (AUSTIN), C/O NELSON AND NELSON, 2984 E. EVERGREEN AVE., SALT LAKE CITY, UT, 84109, US

(73) Assignee: International Business Machines Corporation, Armonk, NY (US)

(21) Appl. No.: 12/173,026

(22) Filed: Jul. 15, 2008

(30) Foreign Application Priority Data
Oct. 30, 2007 (EP) EP07119582

(51) Int. Cl. G06F 11/34

(52) U.S. Cl. 705/11

(57) ABSTRACT

A method for identifying a user having computer skills substantially in accordance with a predetermined skill set. The method may include identifying one or more users, identifying one or more computer skills of the user, and monitoring computer usage of the user to dynamically determine a proficiency level of the user with respect to the computer skill. Embodiments of the method may further include storing the proficiency level in a user profile for the user, and correlating the user profile with a predetermined skill set to identify one or more users having computer skills that best match the predetermined skill set.

### RELATED APPLICATIONS

This application claims priority to European Patent No. EP07119582, filed on Oct. 30, 2007, and entitled “A Method and Apparatus for Improved Management and Allocation of Skills or Resources.”

### BACKGROUND OF THE INVENTION

1. Field of the Invention

Embodiments of the present invention relate to management tools for allocating skills or resources, particularly by means of IT asset management software.

2. Description of the Related Art

In large organizations, and with the globalization of the workforce in those organizations, it has become critical to efficiently and effectively manage employees and their skill sets across different locations and business units. This is necessary to ensure availability of relevant resources or skills for a given business opportunity.

The processes and tools in use today are relatively immature and have a number of limitations. One of the main obstacles to determining a skill inventory of a group of employees is that most methods of assessment are based on predefined skill taxonomies conducted by the employee or by a person responsible for the employee's tasks. This information is time consuming to collect and collate, and is even harder to maintain.

### SUMMARY OF THE INVENTION

The present disclosure has been developed in response to the present state of the art and, in particular, in response to the problems and needs in the art that have not yet been fully solved by currently available tools for managing and allocating skills and resources in a business environment. Accordingly, embodiments of the invention have been developed to provide improved tools for managing and allocating skills and resources by identifying users having computer skills substantially in accordance with a predetermined skill set. The features and advantages of embodiments of the invention will become more fully apparent from the following description and appended claims, or may be learned by practice of embodiments of the invention as set forth hereinafter.

Consistent with the foregoing, embodiments of the present invention include identifying one or more users, identifying one or more computer skills of the user, and monitoring computer usage of the user to dynamically determine a proficiency level of the user with respect to the computer skill. Embodiments of the method may further include storing the proficiency level in a user profile for the user, and correlating the user profile with a predetermined skill set to identify one or more users having computer skills that best match the predetermined skill set.

A corresponding system and computer program product for implementing the above-stated method are also disclosed and claimed herein.

### BRIEF DESCRIPTION OF THE DRAWINGS

In order that the advantages of the disclosure will be readily understood, a more particular description of embodiments of the invention briefly described above will be rendered by reference to specific embodiments illustrated in the appended drawings. Understanding that these drawings depict only typical embodiments of the invention and are not therefore to be considered limiting of its scope, embodiments of the invention will be described and explained with additional specificity and detail through use of the accompanying drawings, in which:

FIG. 1 is a block diagram of the functional elements of an apparatus for managing and allocating skills and resources in accordance with an embodiment of the present invention;

FIG. 2 is a flowchart depicting steps for managing and allocating skills and resources in accordance with an embodiment of the invention; and

FIG. 3 is a representation of a possible entry in a database for effecting the method and apparatus in accordance with an embodiment of the invention.

### DETAILED DESCRIPTION OF THE INVENTION

It will be readily understood that the components of embodiments of the present invention, as generally described and illustrated in the Figures herein, may be arranged and designed in a wide variety of different configurations. Thus, the following more detailed description of the embodiments of the systems and methods of the present invention, as represented in the Figures, is not intended to limit the scope of the disclosure, as claimed, but is merely representative of selected embodiments of the invention.

Reference throughout this specification to “one embodiment,” “an embodiment,” or similar language means that a particular feature, structure, or characteristic described in connection with the embodiment may be included in at least one embodiment of the present invention. Thus, appearances of the phrases “in one embodiment” or “in an embodiment” in various places throughout this specification are not necessarily all referring to the same embodiment.

Furthermore, the described features, structures, or characteristics may be combined in any suitable manner in one or more embodiments. One skilled in the relevant art will recognize, however, that embodiments of the invention can be practiced without one or more of the specific details, or with other methods, components, etc. In other instances, well-known structures, or operations are not shown or described in detail to avoid obscuring aspects of the disclosure.

The illustrated embodiments of the invention will be best understood by reference to the drawings, wherein like parts are designated by like numerals throughout. The following description is intended only by way of example, and simply illustrates certain selected embodiments of the invention that are consistent with the disclosure as claimed herein.

A core idea of embodiments of the present invention is to use existing IT asset management data collected by an IT asset management product and correlate the data and a set of predefined skill profiles to identify, collect and/or determine the skills of a particular user. In order to implement this, the following set of data may be utilized: (1) hardware and software asset data collected from an asset management tool; and (2) a skills catalogue containing a list of skills and their relationship between each skill and the IT asset in accordance with embodiments of the present invention.

These sets of data may then be processed by a software component referred to as a skills correlator, that is responsible for extracting the skills required to use or manage a specific piece of hardware or software. The skills correlator may process the data based on a set of rules, as will be described in greater detail below.

The skills data may then be used to allocate and manage resources, such as human resources which have the skill sets identified. Resources may include skills and users. A skill may be understood as an ability to do something with some level of proficiency, which can belong to a resource and which can bring some value to the user or someone (or something) else if used appropriately.

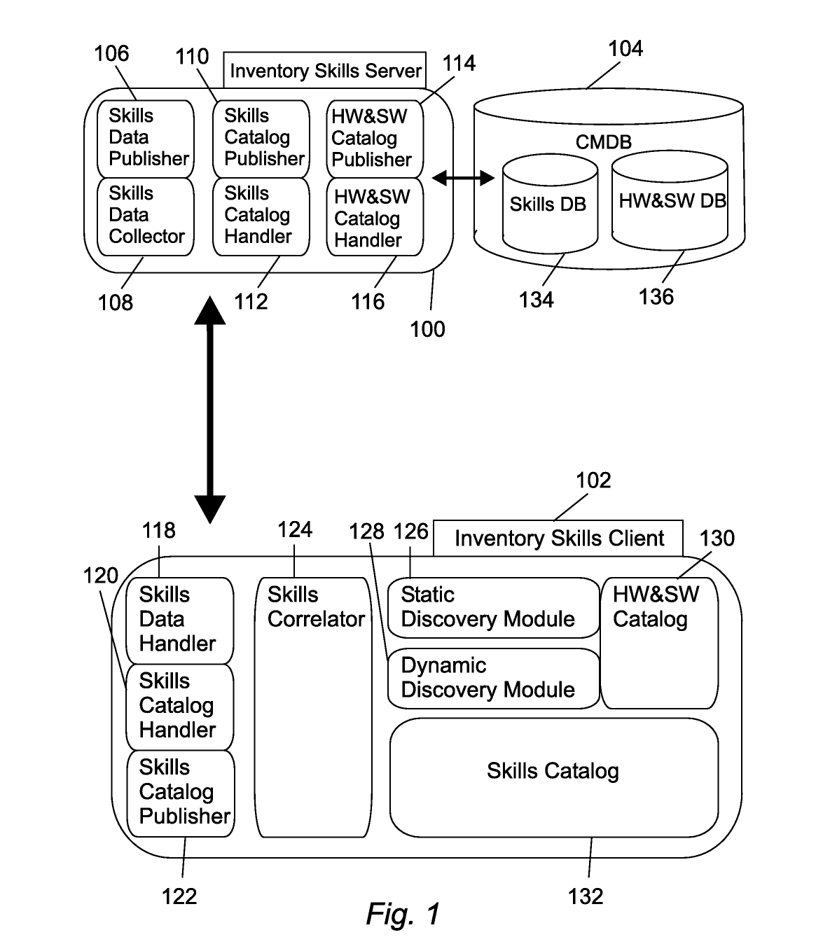

Referring now to FIG. 1, a block diagram of the functional elements of an apparatus in accordance with embodiments of the present invention are shown. The apparatus may include an inventory skills server 100, an inventory skills client 102, and a database 104. The inventory skills server 100 may include: a skills data publisher 106; a skills data collector 108; a skills catalog publisher 110; a skills catalog handler 112; a hardware and software catalog publisher 114; and a hardware and software catalog handler 116. The inventory skills clients may include a skills data handler 118; a skills catalog handler 120, a skills catalog publisher 122, a skills correlator 124, a static discovery module 126, a dynamic discovery module 128, a hardware and software catalog 130, and a skills catalog 132. The database may include a skills database 134 and a hardware and software database 136.

The operation and characteristics of embodiments of the inventory skills server 100 will now be described. Through the hardware and software handler 116, the server 100 may periodically send an updated hardware and software catalog 130 to the client. Similarly, the skills catalog handler 112 may periodically send an updated skills catalog 132 to the client. As will be described below, the inventory skills client 102 may carry out skills inventory processes by means of the static and dynamic discovery modules 126, 128. Any results from the inventory processes may be received through the server 100 by means of the skills data collector 108. These may then be replicated and stored in the database 104.

In addition, skills catalog 132 versions updated on the client 102 side may be received by the skills handler 112, which may merge the date entries into the database 104 in the appropriate section. The hardware and software catalog publisher 114 and the skills catalog publisher 110 may comprise components used by an administrator of the server 100 to provide a centralized way of updating data. The skills data publisher 106 may be used to make the skills data available external from the server 100, to be published in an employee directory or loaded into any other tool used to manage a workforce, for example.

In some embodiments, the inventory skills client 102 may be realized by means of a plug-in for instant messaging clients. The operations and characteristics of embodiments of the inventory skills client 102 will now be described. The hardware and software catalog 130 may be periodically updated by means of the hardware and software catalog handler 116 in the server 100. Similarly, the skills catalog 132 may be periodically updated by means of the skills catalog handler 112 in the server 100. The inventory skills client 102 may also include two discovery modules 126, 128 responsible for static and dynamic discovery of data based on the hardware and software catalog 130 received. The static discovery module 126 may execute a binary match between data in the catalog 130 and data found in the computer system by recognizing the hardware, operating software and/or any other software installed in the system.

The dynamic discovery module 128 may capture real-time data relating to the use of software and hardware resources identified by the static discovery module 126. These two modules (static and dynamic discovery modules 126, 128) may be standard components of IT asset management software.

The skills correlator 124 may collect data from the discovery modules 126, 128 and may use a set of rules to identify the corresponding IT skills in the skills catalog 132. The correlation may be locally stored in the skills data handler 118. A user may then access the results of the skills inventory by means of the skills data handler 118. In addition, the user may add skills that have not been identified by the discovery modules 126, 128, or may update the skills profile contained in the catalog 132 through the skills catalog publisher 122. Both the results from the skills inventory and the skills catalog 132, including any updates, may then be sent back to the skills inventory server 100 through the skills data collector 108 and the skills catalog handler 112, respectively.

Once the inventory of skills is available to the system, the full detail of this may be made available to the user. In some embodiments, the user may validate the output from the inventory by any appropriate means. In other embodiments, the user may enter new skills into the skills inventory if these cannot be easily recognized by the discovery modules 126, 128. As new skills are developed, these may also be entered into the catalog 132.

Changes to hardware and software will generally create an opportunity for users to develop new skills in new areas. These may be entered by a responsible user. In some embodiments, the skills correlator 124 may be augmented by creating customized rules for a particular application or use of the invention. By sharing the inventory with a central repository of skills data, for example Bluepages, it may be possible to share skills information on a broader basis.

The ability to share skills information on a broader basis is important, as it can result in the generation of a much larger skills catalog 132 than a specific client system alone. By periodically checking and updating a client system from a more generally available system, considerable advantages may be recognized.

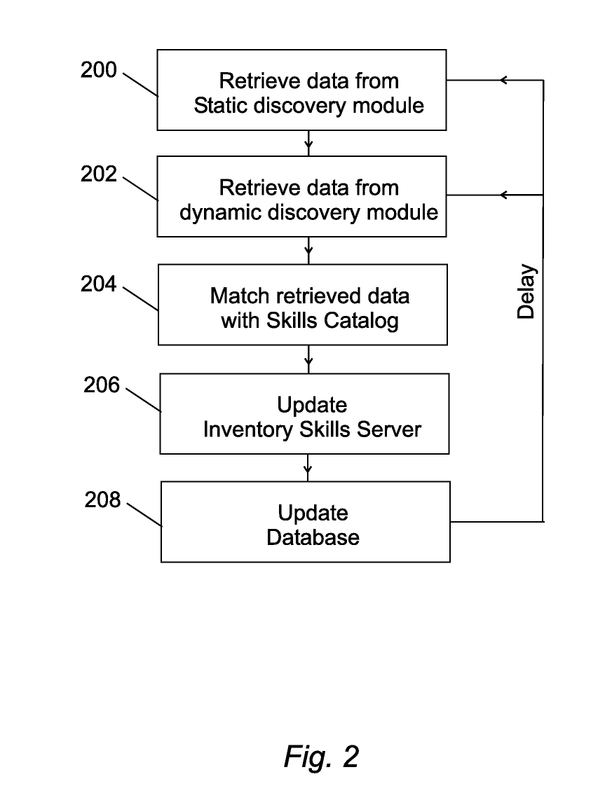

As previously indicated, a core component of embodiments of the system may include the skills correlator 124, which carries out most of the processing. Most of the data and knowledge may be stored in a skills catalog 132. A description of how the skills correlator 124 processes the data now follows, with reference to FIG. 2.

In a step 200, skills correlator 124 may retrieve data from the static discovery module 126. This information may relate to the hardware platform, the operating system platform, static applications installed on either platform, and other information relating to so-called “static signatures.” Static signatures may include indicators or names relating to static applications on a computer of a particular user.

In a step 202, the skills correlator 124 may retrieve “dynamic signatures” from the dynamic discovery module 128 for each installed application. The “dynamic signature” may indicate real-time data associated with the use of the software applications identified by the static discovery module 126.

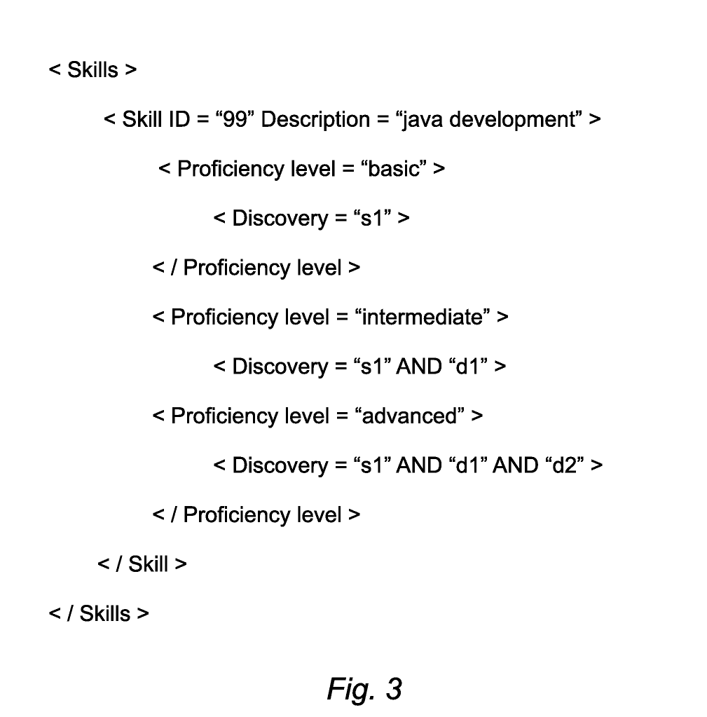

In a step 204, the skills correlator 124 may match the signatures identified in steps 200 and 202 with signatures stored in the skills catalog 132. An example of a skills catalog 132 entry may be as shown in FIG. 3, where s1 is the static signature of a particular application, indicating that this application is installed on the computer in question. The entry d1 is a dynamic feature of the particular application (for example the use of the Javac which indicates that Java code is being built). Similarly, the entry d2 may be another dynamic feature of the application, for example indicating use of a UML2 plug-in to model code.

Any number of additional dynamic discovery modules 128 may be added to the system to extend its discovery capabilities, thereby enabling better matches of the IT skills to the users. The skills catalog 132 may be customized by using a particular taxonomy to define the required skills, as well as to define a particular proficiency level. The skills signature may be different for each proficiency level.

Embodiments of the present invention provide a number of advantages, including the following. The disclosure may allow automation of many activities such that a system administrator or human resources administrator may be provided with a pre-built skills inventory based on IT asset uses. The system administrator or the human resources administrator may be required to do nothing more than validate the data. Further, due to the simple periodic scanning of the skills catalog 132 versions, the skills inventory may be easily maintained and updated. Uploading the modified skills catalog 132 and sharing this between many users may contribute to a broad skills knowledge base which may be accessed by many. In addition, since all the processing may be completed locally, the server 100 may easily manage multiple users.

Embodiments of the present invention provide a further advantage of correlating user activities and using these to identify skills of the user. For example, different computer programs may be used to identify IT skills relating to different sorts of coding. By correlating user activities in this manner, embodiments of the present invention may generate only a relatively small number of false positive results. Specifically, certain embodiments of the present invention may rely on evidence of the user's knowledge and use of a skill, rather than on a string in the document that may suggest a skill. For example, a document may make reference to Java programming. This does not mean the user has skills in that area. To avoid an inference otherwise, embodiments of the present invention may use knowledge of the particular programs used by user to identify a true skill set for the user.

Embodiments may take the form of an entirely hardware embodiment, an entirely software embodiment or an embodiment containing both hardware and software elements. An embodiment that is implemented in software may include, but is not limited to, firmware, resident software, microcode, etc.

Furthermore, embodiments may take the form of a computer program product accessible from a computer-usable or computer-readable medium providing program code for use by or in connection with a computer or any instruction execution system. For the purposes of this description, a computer-usable or computer readable medium includes any apparatus that may contain, store, communicate, propagate, or transport the program for use by or in connection with the instruction execution system, apparatus, or device.

The medium may be an electronic, magnetic, optical, electromagnetic, infrared, or semiconductor system, (or apparatus or device) or a propagation medium. Examples of a computer-readable medium may include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and digital video disk (DVD).

A data processing system suitable for storing and/or executing program code may include at least one processor coupled directly or indirectly to memory elements through a system bus. The memory elements may include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

What is claimed is:

1. A method for identifying a user having computer skills substantially in accordance with a predetermined skill set, the method comprising:
identifying at least one user,
identifying at least one computer skill of the user;
monitoring computer usage of the user to dynamically determine a proficiency level of the user with respect to the computer skill;
storing the proficiency level in a user profile for the user; and
correlating the user profile with a predetermined skill set to identify at least one user having computer skills that best match the predetermined skill set.

2. The method of claim 1, further comprising storing the identified computer skills in the user profile.

3. The method of claim 1, further comprising utilizing an asset management system to identify the at least one computer skill of the user.

4. The method of claim 1, further comprising updating the user profile upon identifying a change in the proficiency level of the user with respect to the computer skill.

5. The method of claim 1, further comprising utilizing an administration process to update computer programs accessed by the user.

6. The method of claim 1, further comprising maintaining a skills catalogue for all users.

8. The method of claim 1, further comprising maintaining a computer program catalogue for all users.

9. The method of claim 1, further comprising displaying the user profile to an operator.

10. The method of claim 1, further comprising displaying the results of the correlating step to an operator for selection of the at least one user.

11. The method of claim 1, further comprising executing the method on at least one of a server system and a client system.

12. A system for identifying a user having computer skills substantially in accordance with a predetermined skill set, the system comprising:
means for identifying at least one user;
means for identifying at least one computer skill of the user;
means for monitoring computer usage of the user to dynamically determine a proficiency level of the user with respect to the computer skill;
means for storing the proficiency level in a user profile for the user, and
means for correlating the user profile with a predetermined skill set to identify at least one user having computer skills that best match the predetermined skill set.

13. The system of claim 12, wherein the system comprises one of a server systemand a client system.

14. The system of claim 12, further comprising means for updating the user profile upon identifying a change in the proficiency level of the user with respect to the computer skill.

15. The system of claim 12, further comprising means for maintaining a skills catalogue for all users.

16. A computer program product for identifying a user having computer skills substantially in accordance with a predetermined skill set, the computer program product comprising a computer-usable medium having computer-usable program code embodied therein, the computer-usable program code comprising:
computer-usable program code for identifying at least one user;
computer-usable program code for identifying at least one computer skill of the user;
computer-usable program code for monitoring computer usage of the user to dynamically determine a proficiency level of the user with respect to the computer skill;
computer-usable program code for storing the proficiency level in a user profile for the user; and
computer-usable program code for correlating the user profile with a predetermined skill set to identify at least one user having computer skills that best match the predetermined skill set.

17. The computer program product of claim 16, further comprising computer-usable program code for storing the identified computer skills in the user profile.

18. The computer program product of claim 16, further comprising computer-usable program code for updating the user profile upon identifying a change in the proficiency level of the user with respect to the computer skill.

19. The computer program product of claim 16, further comprising computer-usable program code for maintaining a skills catalogue for all users.

20. The computer program product of claim 16, further comprising computer-usable program code for displaying the user profile to an operator.
